(19) United States
(12) Patent Application Publication
(10) Pub. No.: US 2015/0113938 A1
(43) Pub. Date: Apr. 30, 2015

(54) WEATHER HOOD WATER REMOVAL SYSTEM AND METHOD FOR ASSEMBLY

(71) Applicant: BHA Altair, LLC, Franklin, TN (US)

(72) Inventors: Bradly Aaron Kippel, Greenville, SC (US); Stephen David Hiner, Salisbury (GB); Timothy John Nicholas, Calmore (GB)

(73) Assignee: BHA Altair, LLC, Franklin, TN (US)

(21) Appl. No.: 14/068,366

(22) Filed: Oct. 31, 2013

(51) Int. Cl. F02C 7/05; B01D 45/04; B01D 46/00; B01D 50/00

(52) U.S. Cl. CPC F02C 7/05; B01D 50/002; B01D 45/04; B01D 46/003
USPC 60/39.092; 29/888.012; 55/332; 55/322; 55/323

(57) ABSTRACT

An air intake system for use with a gas turbine is provided. The air intake system includes a weather hood coupled to a filter house. The air intake system also includes a prefilter assembly configured within said weather hood, wherein said prefilter assembly includes at least three air filtration units, including at least one moisture separator and at least one coalescing filter.

### BACKGROUND

The present disclosure relates generally to gas turbine engine air intake systems and, more specifically, to methods and systems for removing water from air intake weather hoods.

At least some known gas turbine engines for power generation include filter houses for filtration of intake air. At least some known filter houses include a weather hood that is exposed to outdoor conditions such as, but not limited to, rain, mist, fog, salt, and dust. More particularly, at least some known filter houses include a weather hood that has a generally downwardly-oriented air inlet opening, with two filter elements coupled within the weather hood adjacent the opening. In at least some known weather hoods, the opening extends horizontally, while in others, the opening is inclined. In at least some known weather hoods, an inertial separator filter is coupled adjacent the air inlet opening. In at least some known weather hoods, a coalescing filter is coupled downstream from the first inertial separator filter. In such weather hoods, the inertial (“moisture”) separator filter intercepts larger water droplets, permitting passage therethrough of only smaller water droplets. The smaller water droplets are intercepted by the coalescing filter, and combined to form larger water droplets which are drawn out of the coalescing filter and from the weather hood via gravity.

At least some known weather hoods are wedge-shaped, as a result of which localized high-velocity airflow regions may exist within the weather hood. Such high-velocity airflow regions may cause water shedding by filter elements within the weather hood, or water carryover through the weather hood filter elements. Such conditions may cause other filter elements located further downstream from the weather hood filter elements to be undesirably affected. Such undesirable effects include, but are not limited to, undesirable pressure drop across filters located downstream from the weather hood, and/or deliquescence of water soluble contaminates through the filter media.

### BRIEF DESCRIPTION

In an aspect, a method for assembling an air intake system for use with a gas turbine is provided. The method includes coupling a weather hood to a filter house. The weather hood includes an intake opening. The method also includes configuring a prefilter assembly within the weather hood, wherein the prefilter assembly includes at least three air filtration units, including at least one moisture separator and at least one coalescing filter adjacent to the intake opening.

In another aspect, an air intake system for use with a gas turbine is provided. The air intake system includes a weather hood coupled to a filter house. The weather hood includes an intake opening. The air intake system also includes a prefilter assembly configured within the weather hood, wherein the prefilter assembly includes at least three air filtration units, including at least one moisture separator and at least one coalescing filter adjacent to the intake opening.

In another aspect, a gas turbine system is provided. The gas turbine system includes an air intake sub-system, a compressor section, a combustor assembly coupled to the compressor section, and a turbine section coupled to the compressor section. The air intake sub-system includes a weather hood having an intake opening, and a prefilter assembly configured within the weather hood. The prefilter assembly includes at least three air filtration units, including at least one moisture separator and at least one coalescing filter adjacent to the intake opening.

### BRIEF DESCRIPTION OF THE DRAWINGS

FIG. 1 is a block diagram of an exemplary gas turbine system.

FIG. 2 is a sectional side view of an exemplary weather hood prefilter assembly for use in the turbine system shown in FIG. 1.

FIG. 3 is a sectional side view of an alternative weather hood prefilter assembly for use in the gas turbine system shown in FIG. 1.

FIG. 4 is a sectional side view of another alternative weather hood prefilter assembly for use in the gas turbine system shown in FIG. 1.

### DETAILED DESCRIPTION

As used herein, an “inertial separator,” also known as a “moisture separator,” is an air filtration unit that removes large water droplets, for example, larger than about 30 microns in diameter, from an airflow. As used herein, a “coalescing filter” is an air filtration unit that collects and merges (“coalesces”) small water droplets, for example between about 10 microns and about 1 micron in diameter, within an airflow, such that the resulting larger water droplets are collected by a drip tray or gutter coupled to the coalescing filter to channel the larger water droplets away from the coalescing filter.

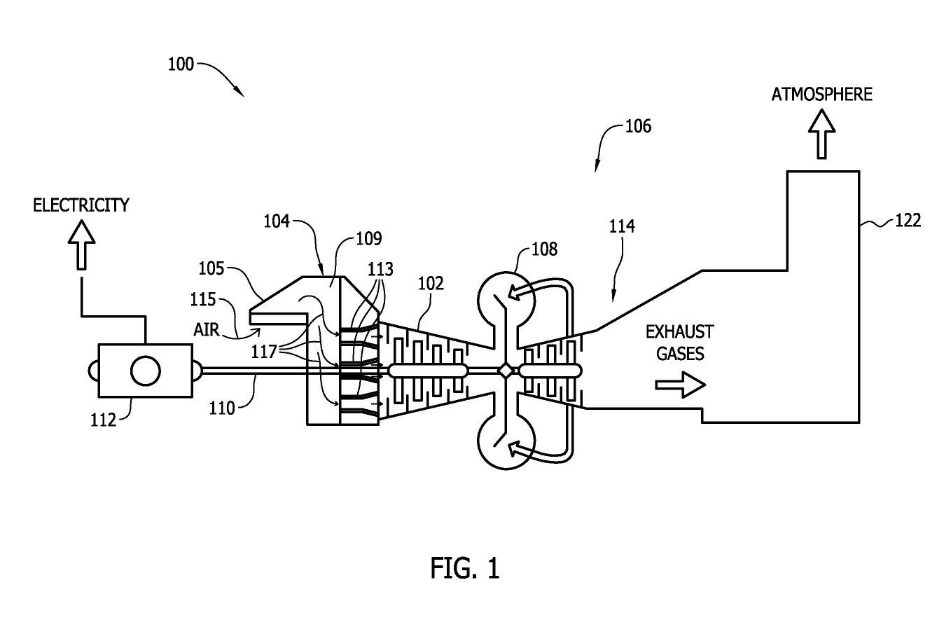

FIG. 1 is a simplified schematic diagram of a gas turbine system 100. In the exemplary embodiment, gas turbine system 100 includes a compressor 102 including an air intake 104 that receives air. Compressor 102 is coupled to a turbine section 106. Gas turbine system 102 also includes one or more combustion chambers 108. Compressor 102 compresses air received via air intake 104 and channels the compressed air into combustion chambers 108, wherein the compressed air is mixed with fuel and ignited to supply turbine section 106 with hot combustion gases for driving a first shaft 110. In the exemplary embodiment, first shaft 110 is coupled to a first generator 112, and causes first generator 112 to generate electricity. In an alternative embodiment, shaft 110 may be coupled to any load that requires rotational input, such as, but not limited to, a pump or a compressor. Turbine section 106 discharges exhaust gases into an exhaust duct 114 that are eventually vented via a stack 122 to atmosphere.

In the exemplary embodiment, air intake 104 includes a filter house 109. At least one weather hood 105 is coupled to filter house 109, such that weather hood 105 is exposed to, and intakes air 115. Intake air 115 is pre-filtered by at least one filter configured within weather hood 105. Prefiltered air 117 is then channeled to at least one filter 113 that is downstream from weather hood 105. In the exemplary embodiment, filter 113 may have any configuration that enables system 100 to function as described herein, such as, but not limited to, a self-cleaning filter or a static filter.

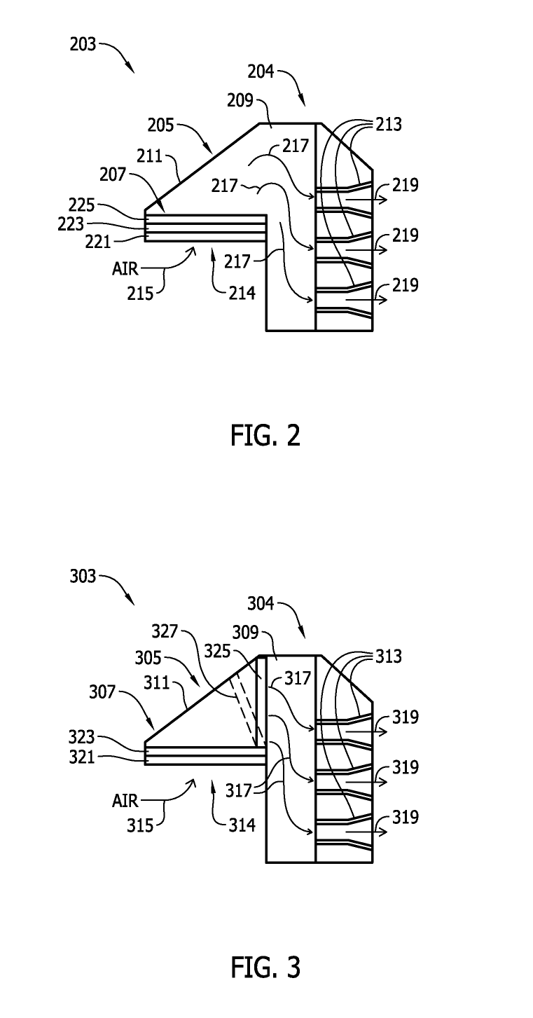

FIG. 2 is a side sectional view of an exemplary air intake system 203 for use in gas turbine system 100 (shown in FIG. 1). Air intake system 203 includes a filter house 204 with a weather hood 205. In the exemplary embodiment, weather hood 205 includes an inclined planar wall 211 oriented adjacent a generally downwardly-oriented intake opening 214. In an alternative embodiment, wall 211 may be curved (for example, upwardly convex), partially curved and partially planar, or may have any other configuration that enables weather hood 205 to function as described herein. Moreover, opening 214 may be horizontal, inclined, or have any other configuration that enables weather hood 205 to function as described herein. A prefilter assembly 207 is configured within weather hood 205 adjacent intake opening 214. Prefilter assembly 207 includes a first coalescing filter 221, a moisture separator 223 that is downstream from first coalescing filter 221, and a second coalescing filter 225 that is downstream from moisture separator 223. Coalescing filters 221 and/or 225 may have any configuration, including but not limited to, a bag-type configuration or a panel-type configuration, that enables filter house 204 to function as described herein. Likewise, moisture separator 223 may have any suitable configuration, including but not limited to, a drift eliminator-type configuration, or a vane-type configuration, that enables prefilter assembly 207 to function as described herein. One or more filters 213 are located downstream from weather hood 205. In the exemplary embodiment, each filter 213 may have any configuration that enables filter house 204 to function as described herein.

During operation, intake air 215 is drawn, for example, by a pressure differential created by compressor 102 (shown in FIG. 1), into weather hood 205. Intake air 215 may include water droplets, dissolved salt, dust and/or other substances that may need to be removed from intake air 215, to prevent adverse impacts on operation of gas turbine engine 106 (shown in FIG. 1). First coalescing filter 221 removes a portion of the moisture from air 215. Large water droplets (not shown) that coalesce in filter 221 are drawn out by gravity. Moisture separator 223 removes from air 215 large water droplets (not shown) that are shed by coalescing filter 221, are drawn out by gravity. Second coalescing filter 225 removes additional moisture from air 215, resulting in prefiltered air 217 that is discharged into an airflow plenum 209. As a result of the presence of filter 221 and moisture separator 223, filter 225 experiences less moisture in air 215 and sheds less moisture, than otherwise would occur in the absence of filter 221. Accordingly, less moisture remains in prefiltered air 217 to cause wetting of filters 213.

Prefiltered air 217 is channeled by plenum 209 to filters 213, which discharge filtered air 219. In the exemplary embodiment, a plurality of filters 213 is configured in filter house 204 downstream from coalescing filter 225. In an alternative embodiment, any number of filters 213 are used that enables filter house 204 to function as described herein. Filtered air 219 is channeled to compressor 102 (shown in FIG. 1). As described above, filter house 204 facilitates removal of moisture from ambient intake air 215, resulting in less exposure to moisture experienced by coalescing filter 225, which results in less shedding of water droplets by filter 225 back into prefiltered air 217 downstream from moisture separator 223.

FIG. 3 is a side sectional view of an alternative air intake system 303 for use in gas turbine system 100 (shown in FIG. 1). Air intake system 303 includes a filter house 304 with a weather hood 305. In the exemplary embodiment, weather hood 305 includes an inclined planar wall 311 oriented adjacent a generally downwardly-oriented intake opening 314. In an alternative embodiment, wall 311 may be curved (for example, upwardly convex), partially curved and partially planar, or may have any other configuration that enables weather hood 305 to function as described herein. Moreover, opening 314 may be horizontal, inclined, or have any other configuration that enables weather hood 305 to function as described herein. A prefilter assembly 307 is coupled within weather hood 305 adjacent intake opening 314. In the exemplary embodiment, prefilter assembly 307 includes a moisture separator 321 and a coalescing filter 323. In the exemplary embodiment, prefilter assembly 307 also includes a second, vertically-oriented moisture separator 325 that is downstream from coalescing filter 323. Each of moisture separators 321 and 325, and coalescing filter 323 may have any suitable configuration that enables prefilter assembly 307 to function as described herein. In an alternative embodiment, instead of vertical moisture separator 325, a moisture separator 327 may be oriented in a configuration other than vertical. For example, moisture separator 327 may be oriented at an oblique angle toward moisture separator 321 and coalescing filter 323, and away from plenum 309, to facilitate channeling collected moisture away from separator 327 and into a collection device (not shown) such, but not limited to, a drip tray or gutter configured below separator 327.

In operation, moisture separator 321 removes a portion of moisture from air 315. Coalescing filter 323 causes small moisture droplets to coalesce into larger moisture droplets that are discharged from coalescing filter 323 via gravity. Moisture separator 325 removes from air 315 large water droplets that may be shed by coalescing filter 323 into air 315. Prefiltered air 317 is discharged from moisture separator 325 and channeled through an airflow plenum 309 into at least one filter 313. In the exemplary embodiment, a plurality of filters 313 is configured in filter house 304 downstream from moisture separator 325. In an alternative embodiment, any number of filters 313 are used that enables filter house 304 to function as described herein. Moreover, each filter 313 may have any configuration that enables filter house 304 to function as described herein. Filtered air 319 is discharged from filter house 304 and channeled into compressor 102 (shown in FIG. 1). Through use of moisture separator 325, less moisture is present in prefiltered air 317, resulting in less wetting of filters 313.

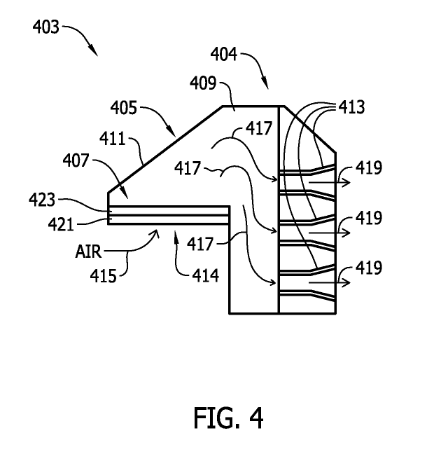

FIG. 4 is a side sectional view of another alternative air intake system 403 for use in gas turbine system 100 (shown in FIG. 1). Air intake system 403 includes a filter house 404 with a weather hood 405. In the exemplary embodiment, weather hood 405 includes an inclined planar wall 411 oriented adjacent a generally downwardly-oriented intake opening 414. In an alternative embodiment, wall 411 may be curved (for example, upwardly convex), partially curved and partially planar, or may have any other configuration that enables weather hood 205 to function as described herein. Moreover, opening 414 may be horizontal, inclined, or have any other configuration that enables weather hood 405 to function as described herein. A prefilter assembly 407 is configured within weather hood 405 adjacent intake opening 414. Prefilter assembly 407 includes a coalescing filter 421, and a moisture separator 423 that is downstream from coalescing filter 421. Coalescing filter 421 may have any configuration, including but not limited to, a bag-type configuration or a panel-type configuration, that enables filter house 404 to function as described herein. Likewise, moisture separator 423 may have any suitable configuration, including but not limited to, a drift eliminator-type configuration, or a vane-type configuration, that enables prefilter assembly 407 to function as described herein. One or more filters 413 are located downstream from weather hood 405. In the exemplary embodiment, each filter 413 may have any configuration that enables filter house 404 to function as described herein.

During operation, intake air 415 is drawn, for example, by a pressure differential created by compressor 102 (shown in FIG. 1), into weather hood 405. Intake air 415 may include water droplets, dissolved salt, dust and/or other substances that may need to be removed from intake air 415, to prevent adverse impacts on operation of gas turbine engine 106 (shown in FIG. 1). Coalescing filter 421 removes a portion of the moisture from air 415. Large water droplets (not shown) that coalesce in filter 421 are drawn out by gravity. Moisture separator 423 removes from air 415 large water droplets (not shown) that are shed by coalescing filter 421. The large water droplets removed by moisture separator 423 are drawn out of weather hood 405 by gravity, resulting in prefiltered air 417 that is discharged into an airflow plenum 409. Accordingly, less moisture remains in prefiltered air 417 to cause wetting of filters 413.

Prefiltered air 417 is channeled by plenum 409 to filters 413, which discharge filtered air 419. In the exemplary embodiment, a plurality of filters 413 is configured in filter house 404. In an alternative embodiment, any number of filters 413 is used that enables filter house 404 to function as described herein. Filtered air 419 is channeled to compressor 102 (shown in FIG. 1).

The disclosure described herein provides advantages over known systems and methods for assembling weather hoods for use in filter houses for gas turbine systems. Specifically, the systems and methods described herein facilitate removing large water droplets that may be shed by coalescing filters and carried by intake airflow into downstream filters. The systems and methods described herein facilitate removal of additional moisture from ambient intake air flow by providing a prefilter assembly within a weather hood of a filter house, wherein the prefilter assembly includes at least three air filtration units, including at least one moisture separator and at least one coalescing filter.

Exemplary embodiments of weather hoods and methods for assembling same are described above in detail. The systems and methods are not limited to the specific embodiments described herein, but rather, actions of the methods and/or components of the systems may be utilized independently and separately from other components and/or actions described herein. For example, the systems and methods described herein are not limited to practice only with gas turbine engine systems, but also may be used in combination with other devices that incorporate air filters that intake and filter outdoor air, such as, but not limited to, heating, ventilation, and air conditioning (“HVAC”) systems for use in commercial and residential buildings, and other structures.

The systems and methods are not limited to the specific embodiments described herein, but rather, operations of the methods and/or components of the systems may be utilized independently and separately from other components and/or actions described herein. The method operations described herein are just examples. There may be many variations to the operations described therein without departing from the spirit of the disclosure. For instance, except as specifically described, the actions may be performed in a differing order, or actions may be added, deleted or modified. All of these variations are considered a part of the claimed subject matter.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the systems and methods described herein, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the disclosure has been described in terms of various specific embodiments, those skilled in the art will recognize that the disclosure may be practiced with modification within the spirit and scope of the claims.

What is claimed is:

1. A method for assembling an air intake system for use with a gas turbine, said method comprising:
coupling a weather hood to a filter house, wherein the weather hood includes an intake opening; and
configuring a prefilter assembly within the weather hood, wherein the prefilter assembly includes at least three air filtration units, including at least one moisture separator and at least one coalescing filter adjacent to the intake opening.

2. A method in accordance with claim 1, wherein configuring a prefilter assembly within the weather hood comprises:
configuring a first coalescing filter adjacent to the intake opening;
configuring a moisture separator adjacent to and downstream from the first coalescing filter; and
configuring a second coalescing filter adjacent to and downstream from the moisture separator.

3. A method in accordance with claim 1, wherein configuring a prefilter assembly within the weather hood comprises:
configuring a first moisture separator adjacent to the intake opening;
configuring a coalescing filter adjacent to the moisture separator; and
configuring a vertically-oriented second moisture separator downstream from the coalescing filter.

4. A method in accordance with claim 1, wherein said method further comprises defining a wall in the weather hood adjacent to the intake opening, wherein the wall has a configuration that is one of inclined planar and curved.

5. A method in accordance with claim 4, wherein said method further comprises defining an airflow plenum downstream from the inclined wall.

6. A method in accordance with claim 1, wherein configuring a prefilter assembly within the weather hood comprises:
configuring a first moisture separator adjacent to the intake opening;
configuring a coalescing filter adjacent to the moisture separator; and
configuring a second moisture separator within the weather hood at an oblique angle relative to at least one of the first moisture separator and the coalescing filter.

7. A method in accordance with claim 1, wherein said method further comprises configuring at least one filter downstream from the prefilter assembly.

8. An air intake system comprising:
a weather hood coupled to a filter house, wherein said weather hood includes an intake opening; and
a prefilter assembly configured within said weather hood, wherein said prefilter assembly includes at least three air filtration units, including at least one moisture separator and at least one coalescing filter adjacent to the intake opening.

9. An air intake system in accordance with claim 8, wherein said prefilter assembly comprises:
a first coalescing filter configured adjacent to the intake opening;
a moisture separator configured adjacent to and downstream from said first coalescing filter; and
a second coalescing filter configured adjacent to and downstream from said moisture separator.

10. An air intake system in accordance with claim 8, wherein said prefilter assembly comprises:
a first moisture separator configured adjacent to the intake opening;
a coalescing filter configured adjacent to said moisture separator; and
a vertically-oriented second moisture separator configured downstream from said coalescing filter.

11. An air intake system in accordance with claim 8, wherein said weather hood further comprises a wall configured adjacent to said intake opening, wherein said wall has a configuration that is one of inclined planar and curved.

12. An air intake system in accordance with claim 11, wherein said weather hood further comprises an airflow plenum configured downstream from said inclined wall.

13. An air intake system in accordance with claim 8, wherein said prefilter assembly comprises:
a first moisture separator configured adjacent to the intake opening;
a coalescing filter configured adjacent to said moisture separator; and
a second moisture separator configured downstream from said coalescing filter at an oblique angle with respect to at least one of the first moisture separator and the coalescing filter.

14. An air intake system in accordance with claim 8, wherein said air intake system further comprises at least one filter configured downstream from said prefilter assembly.

15. A gas turbine system, said system comprising:
an air intake sub-system;
a compressor section coupled to said air intake sub-system;
a combustor assembly coupled to said compressor section; and
a turbine section coupled to said compressor section, wherein said air intake sub-system includes a weather hood having an intake opening, and a prefilter assembly configured within said weather hood, wherein said prefilter assembly includes at least three air filtration units, including at least one moisture separator and at least one coalescing filter adjacent to the intake opening.

16. A gas turbine system in accordance with claim 15, wherein said prefilter assembly comprises:
a first coalescing filter configured adjacent to the intake opening;
a moisture separator configured adjacent to and downstream from said first coalescing filter; and
a second coalescing filter configured adjacent to and downstream from said moisture separator.

17. A gas turbine system in accordance with claim 15, wherein said prefilter assembly comprises:
a first moisture separator configured adjacent to the intake opening;
a coalescing filter configured adjacent to said moisture separator; and
a vertically-oriented second moisture separator configured downstream from said coalescing filter.

18. A gas turbine system in accordance with claim 15, wherein said weather hood further comprises a wall configured adjacent to said intake opening, wherein said wall has a configuration that is one of inclined planar and curved.

19. A gas turbine system in accordance with claim 18, wherein said weather hood further comprises an airflow plenum configured downstream from said inclined wall.

20. A gas turbine system in accordance with claim 15, wherein said prefilter assembly comprises:
a first moisture separator configured adjacent to the intake opening;
a coalescing filter configured adjacent to said moisture separator; and
a second moisture separator configured downstream from said coalescing filter at an oblique angle with respect to at least one of said first moisture separator and said coalescing filter.
